(19) United States
(12) Patent Application Publication
(10) Pub. No.: US 2011/0249532 A1
(43) Pub. Date: Oct. 13, 2011

(54) Ticker tape watch

(76) Inventor: Henry Joseph Leason, Laguna Hills, CA (US)

(21) Appl. No.: 13/065,715

(22) Filed: Mar. 29, 2011

Related U.S. Application Data
(60) Provisional application No. 61/342,005, filed on Apr. 8, 2010.

(51) Int. Cl. G04C 17/00; G04B 19/24

(52) U.S. Cl. 368/30; 368/242

(57) ABSTRACT

The Ticker tape watch the present invention has integrated electronic components and an LCD display panel. A standard watch battery can power the watch. The most notable aspect of that ticker tape watch of the present invention is that watch clearly displays time, date and year as a scrolling ticker tape.

The watch will have a mini-computer that will be programmable for the operation of the watch besides the time, date and year, the watch will be programmable by USB ports record for advertising, for example; prior to displaying time, the ticker tape will be programmed to read it's Miller time or it's time to have a Coke.

Activated by the user, the advertising, the time or date scroll across the front of the watch from right to left, with the watch set to continuously scroll or to scroll on demand.

The user can periodically check the time, simply by glancing at their watch and pressing the first push button once to display the time, or twice to Display the date time and year. In order to display time in ticker tape scroll, the user presses the third button, and thus that time including hour, minutes and seconds, as well as the date including month and day of the week as well as a year will scroll across the front of the watch, creating a striking visual effect.

### BACKGROUND OF THE INVENTION

1. Field of the Invention

This invention relates generally to a ticker tape watch and, more particularly, the invention relates to a ticker tape watch for displaying time as a ticker tape scroll.

2. Description of the Prior Art

A favorite fashion accessory worn by men and women alike is jewelry. Worn by people from all walks of life, earrings, necklaces, bracelets and rings, complement a person's wardrobe and offer that person a simple means in which to express individual style. Perhaps the most popular of all jewelry accessories is the common wristwatch. Wristwatches are practical accessories which serve the dual function of complimenting a person's wardrobe, while providing the wearer instant access to the time. Watches are such useful accessories, that many consumers would not think of leaving home without first strapping a watch across their wrist. Because so many people wear wristwatches, companies such as Rolex, Buliva, Timex, and Swatch are continuously introducing new and unique watches to their individual product lines, all in attempts to meet the ever growing demand of consumers.

### BRIEF DESCRIPTION OF THE DRAWINGS

FIGS. 1-3 are perspective views illustrating a ticker tape watch, constructed in accordance with the present invention.

### DETAILED DESCRIPTION OF THE PREFERRED EMBODIMENTS

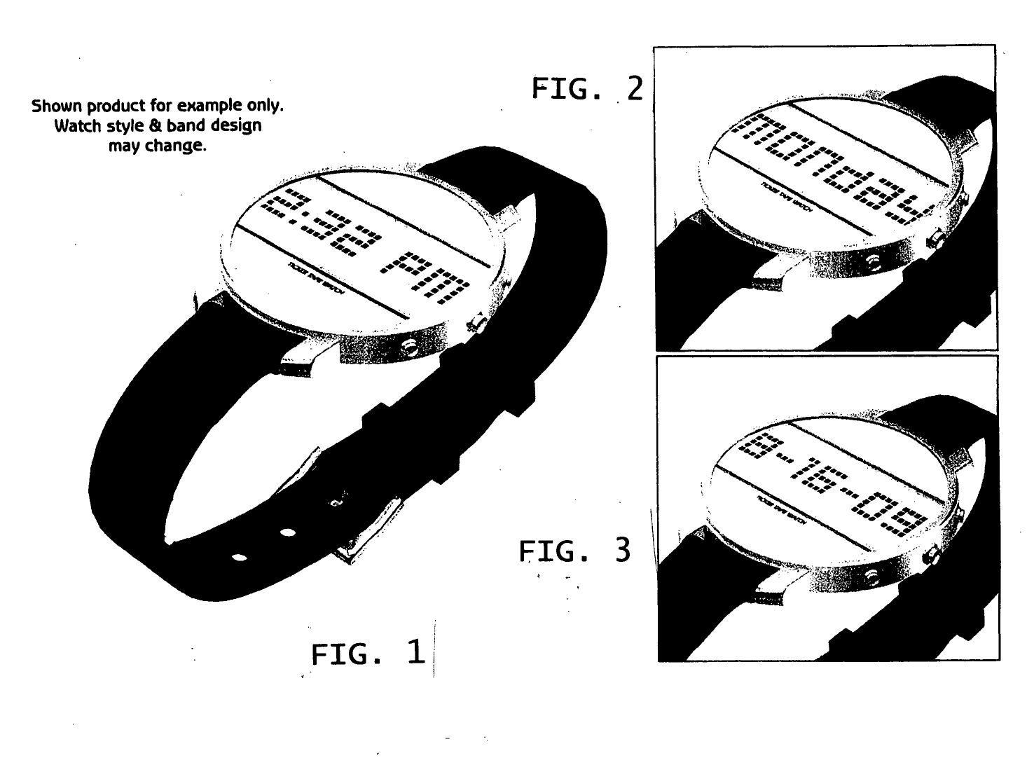

As illustrated in FIGS. 1-3, the present invention is a ticker tape watch suitable for wear by both male and female consumers and displaying time in a ticker tape scroll. The ticker tape watch is a digital watch. As such, individual watches from the line feature timepieces in circular, square, or rectangular shapes, with each timepiece securely attached to two, comfortable buckled wrist straps. The straps are preferably constructed of leather, canvas, or nylon material and can be produced in an array of colors to correspond with the timepieces, as well as standard black, beige, or white. Additionally, the straps can be constructed of solid or plated silver, gold or platinum links.

The ticker tape watch of the present invention has integrated electronic components and an LCD display panel. A standard watch battery can power the watch. Positioned on the side of the watch are series of three, push button knobs enabling the user to easily set the hour, minute, and second hands, as well as day of the week. The watch face itself is protected by a gently contoured, polished crystal, allowing the wearer to clearly read the displayed time.

The most notable aspect of the ticker tape watch of the present invention is that the watch clearly displays time as a scrolling ticker tape. Activated by the user, the time or date scroll across the front of the watch from right to left, with the watch set to continuously scroll, or to scroll on demand.

Application and wear of ticker tape watch of the present invention is very simple and straightforward. First, the user selects an individual watch from the collection according to personal preference. Once purchased, the user sets the watch to the proper time (via the middle operational button), donning the watch as they would any other wrist watch. Wrapping the wrist straps around the wrist, the user secures the buckled closure for a comfortable fit. The user can then periodically check the time, simply by glancing at their watch and pressing the first push button once to display the time, or twice to display the date and time. In order to display time in a ticker tape scroll, the user depresses the third, lowest button, thus the time (including hour, minutes, and seconds), as well as the date (including month and day of the week) scroll across the front of the watch, creating a striking visual effect.

The ticker tape watch of the present invention offers users a new and unique style of wristwatch. Providing a novel twist on standard wristwatch designs, the ticker tape watch displays time in the stylish and distinct manner of a ticker tape scroll. Providing an exciting addition to the watch market, the watch offers a novel conversation piece and a unique accessory which sets them apart from their peers. Another important advantage to the watch is that this watch provides users an accurate, precision timepiece. In addition to offering time in scrolling increments, the watch clearly displays the precise hour, minute, and second, as well as the date providing a reliable wristwatch ensuring the wearer will always know the exact time.

Accurate and unique, the ticker tape watch of the present invention provides users a striking, yet functional timepiece. With time displayed in traditional and scrolling manner, this cleverly designed wristwatch offers a simple means of showcasing one's individuality.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed:

1. The tickertape watch substantially as described and illustrated herein.

2. All inventions described and illustrated herein.

3. The watch will be a mini-computer to make changes as to time, date, year and advertisement.
